(19) United States
(12) Patent Application Publication
(10) Pub. No.: US 2023/0211797 A1
(43) Pub. Date: Jul. 6, 2023

(54) ECO-FRIENDLY VEHICLE AND METHOD FOR EVALUATING VALET MODE THEREFOR

(71) Applicants: Hyundai Motor Company, Seoul (KR); Kia Corporation, Seoul (KR)

(72) Inventors: Gyu Ri Lee, Namyangju-si (KR); Hui Un Son, Suwon-si (KR); Sung Il Jung, Busan (KR)

(21) Appl. No.: 17/977,694

(22) Filed: Oct. 31, 2022

(30) Foreign Application Priority Data
Jan. 4, 2022 (KR) 10-2022-0000833

(51) Int. Cl. B60W 50/12; B60W 50/10; B60H 1/00

(52) U.S. Cl. CPC B60W 50/12; B60W 50/10; B60H 1/008; B60H 3/00

(57) ABSTRACT

Disclosed are methods, apparatuses, and systems for controlling a valet mode of a vehicle. The method may include determining whether or not one or more vehicle takeover mode entry conditions are satisfied while a vehicle is in the valet mode, requesting one of a plurality of takeover controls for a vehicle takeover mode based on a determination that the one or more vehicle takeover mode entry conditions are satisfied and further based on a status of the vehicle, and performing the requested takeover control on the vehicle by adjusting a limitation that is applied, in the valet mode, to the vehicle.

This application claims the benefit of Korean Patent Application No. 10-2022-0000833, filed on Jan. 4, 2022, which is hereby incorporated by reference in its entirety.

### BACKGROUND

### Field

The present disclosure relates to eco-friendly vehicles and more specifically to a method for controlling air-conditioning in a valet mode.

### Discussion of the Related Art

A valet mode may indicate a driving mode that allows a vehicle's owner to restrict or limit certain functions of the vehicle when the owner of the vehicle allows other people to drive the vehicle temporarily, as during a valet parking service. The vehicle owner may expose only necessary information and functions to the valet driver to protect personal information, before relinquishing control of the vehicle over to the valet driver.

However, the conventional valet mode as described above is simply controlled in an on-off mode and thus detailed control of the valet mode depending on the situation is impossible, and characteristics of electric vehicles (EVs) or hybrid electric vehicles (HEVs), which have become more popular in recent years, are not considered in the valet mode.

For example, when allowing a stranger (e.g., a valet driver) to drive the vehicle in the valet mode, there is a concern about possible contamination of the vehicle by infectious diseases, such as COVID-19. The vehicle owner may also need to disinfect and ventilate the interior of the vehicle after the vehicle owner takes over the vehicle and before driving the vehicle, which may cause inconveniences to the owner.

Further, since the vehicle may enter a limited control mode depending on a level of the valet mode, the vehicle owner may need to undergo many inconveniences of controlling the internal environment of the vehicle.

### SUMMARY

Accordingly, the present disclosure is directed to eco-friendly vehicles (e.g., hybrid vehicles, electric vehicles, etc.) and a method for controlling a valet mode therefor that substantially obviate one or more problems due to limitations and disadvantages of the related art.

The present disclosure will discuss eco-friendly vehicles and provide one or more methods for controlling a valet mode therefor which may execute a vehicle takeover mode during the valet mode of the eco-friendly vehicle, and may thus control air-conditioning to clean (e.g., purify and/or filter) the air inside the eco-friendly vehicle before a vehicle owner takes over the eco-friendly vehicle.

The present disclosure will also discuss an eco-friendly vehicle and provide one or more methods for controlling a valet mode therefor which may discharge the air inside the vehicle to the exterior to rapidly and thoroughly ventilate the interior of the vehicle, or may perform air-cleaning, air purification control, vehicle status restoration, limit degree mitigation (e.g., valet mode-specialized control), etc., before a vehicle owner takes over the eco-friendly vehicle, so as to provide convenience to the vehicle owner.

The present disclosure provides one or more methods for controlling a valet mode therefor which may perform air-cleaning and purification (e.g., filtering), air-conditioning control, etc., at a point in time selected by a vehicle owner using an infectious disease risk index, air quality, target cleanliness, usage conditions that trigger cleaning as selected by the vehicle owner, a valet mode signal, etc. before the vehicle owner takes over the eco-friendly vehicle in the valet mode of the eco-friendly vehicle.

Additional advantages, objects, and features of the disclosure will be set forth in part in the description which follows and in part will become apparent to those having ordinary skill in the art upon examination of the following, or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, one or more methods for controlling a valet mode of a vehicle may include determining, by one or more processors and while a vehicle is in a valet mode, whether one or more vehicle takeover mode entry conditions are satisfied, requesting, based on a determination that the one or more vehicle takeover mode entry conditions are satisfied and further based on a status of the vehicle, one of a plurality of takeover controls for a vehicle takeover mode, and performing the requested takeover control on the vehicle by adjusting a limitation that is applied, in the valet mode, to the vehicle.

An apparatus for controlling a valet mode of a vehicle may include one or more processors, and memory storing instructions that, when executed by the one or more processors, cause the apparatus to determine, while the vehicle is in the valet mode, whether one or more vehicle takeover mode entry conditions are satisfied, request, based on a determination that the one or more vehicle takeover mode entry conditions are satisfied and further based on a status of the vehicle, one of a plurality of takeover controls for a vehicle takeover mode, and perform the requested takeover control on the vehicle by adjusting a limitation that is applied, in the valet mode, to the vehicle.

A non-transitory computer-readable storage medium storing instructions, when executed by one or more processors, cause an apparatus to determine, while the vehicle is in the valet mode, whether one or more vehicle takeover mode entry conditions are satisfied, request, based on a determination that the one or more vehicle takeover mode entry conditions are satisfied and further based on a status of the vehicle, one of a plurality of takeover controls for a vehicle takeover mode, and perform the requested takeover control on the vehicle by adjusting a limitation that is applied, in the valet mode, to the vehicle.

It is to be understood that both the foregoing general description and the following detailed description of the present disclosure are exemplary and explanatory and are intended to provide further explanation.

### BRIEF DESCRIPTION OF THE DRAWINGS

The accompanying drawings, which are included to provide a further understanding of the d disclosure and are incorporated in and constitute a part of this application, illustrate embodiment(s) of the disclosure and together with the description serve to explain the principle of the disclosure. In the drawings:

FIG. 1 is a block diagram showing an example of the configuration of a valet mode control unit which controls a valet mode;

FIGS. 2A and 2(b) are diagrams showing an example of implementation of a vehicle takeover mode;

FIG. 3 is a diagram illustrating an example operation of an air-conditioning control unit under the control of the valet mode control unit; and

FIG. 4 is a flowchart representing an example of a process of controlling the vehicle takeover mode during the valet mode.

### DETAILED DESCRIPTION

Reference will now be made in detail to embodiments of the present disclosure, examples of which are illustrated in the accompanying drawings. Wherever possible, the same reference numbers will be used throughout the drawings to refer to the same or like parts, and redundant description thereof will be omitted.

As used herein, the suffixes “module” and “unit” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification.

In addition, it should be noted that the accompanying drawings are only for easy understanding of the embodiments disclosed in the present specification, and should not be construed as limiting the technical spirit disclosed in the present specification, and it will be understood that the embodiments specified in the following description and the configuration shown in the drawings cover modifications, equivalents or alternatives which come within the scope and technical range of the present disclosure at the time of application thereof.

In the following description of the embodiments, terms, such as “first” and “second”, are used only to describe various elements, and these elements should not be construed as being limited by these terms. These terms are used only to distinguish one element from other elements.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present.

As used herein, singular forms may be intended to include plural forms as well, unless the context clearly indicates otherwise.

In the following description of the embodiments, the terms “comprises,” “comprising,” “including,” and “having” are inclusive and therefore specify the presence of stated features, integers, steps, operations, elements, components, and/or combinations thereof, but do not preclude the presence or addition of one or more other features, integers, steps, operations, elements, components, and/or combinations thereof.

Further, the term “control unit” included in, for example, motor control unit (MCU), hybrid control unit (HCU), etc., may be widely used to refer to a controller configured to control a specific function of a vehicle, but may not mean a generic functional unit. For example, each control unit may include a communication device (e.g., a network adapter, etc.) configured to communicate with other controllers or sensors, a memory (e.g., random-access memory (RAM), read-only memory (ROM), an electrically erasable programmable read-only memory (EEPROM), flash memory, solid-state memory, a magnetic drive, an optical drive, etc.) configured to store operating system(s), logic commands (e.g., instructions), input and output information, etc., and at least one processor (e.g., central processing unit (CPU), a graphics processing unit (GPU), a field-programmable gate array (FPGA), an application-specific integrated circuit (ASIC), etc.) configured to perform determination, calculation, judgement, etc. necessary to control a function assigned to the controller so as to control the function.

Embodiments of the present disclosure suggest controlling air-conditioning to clean and/or air condition the interior (e.g., cabin) atmosphere (e.g., air) of an eco-friendly vehicle before a primary driver (e.g., a vehicle owner) takes over the vehicle in a vehicle takeover mode during the valet mode of the eco-friendly vehicle.

Further, the embodiments of the present disclosure suggest performing air-cleaning and purification, air-conditioning control, etc., at a point in time selected by the vehicle owner using an infectious disease risk index, air quality, target cleanliness, usage conditions that trigger cleaning as selected by the vehicle owner, a valet mode signal, etc. before the vehicle owner takes over the eco-friendly vehicle in the valet mode of the eco-friendly vehicle.

The “valet mode” described hereinafter may indicate a mode (e.g., a driving mode), in which one or more settings of the vehicle are changed or at least some functions and performances are limited when a primary driver is replaced with a secondary driver. A primary driver (also referred to as a primary operator) may refer to a driver who has primary control over the vehicle and/or drives the vehicle on a regular basis, such as a vehicle owner of an eco-friendly vehicle, a main driver, a family member, or any driver who drives the eco-friendly vehicle to a specific region in which a driver exchange is expected. A secondary driver (also referred to as a secondary operator) may refer to a temporary driver, such as a valet driver, any driver that is temporarily authorized by the primary driver for driving the vehicle after the driver exchange. In addition, the “vehicle takeover mode” (also referred to as a “vehicle handover mode”) may indicate a mode (e.g., a driving mode) in which limitations on at least some functions and performances (e.g., the limitations put in place during the valet mode) are removed and/or released, after a secondary driver (e.g., a valet driver) drives the vehicle to a place desired by the primary driver (e.g., a vehicle owner) in valet mode.

Further, types of execution, change and limitation of vehicle functions expressed as a plurality of levels may include at least one of 1) a power threshold for a hybrid an engine/motor to transition from its gasoline powertrain to a hybrid (e.g., electric) powertrain, 2) air-conditioning performance control, 3) speed limit, 4) acceleration limit, 5) parking impact reduction, 6) a driver evaluation function, 7) a parking spot feedback function, 8) a drive mode (an eco, normal or sports mode) limit function, or 9) a safety function. This will be set forth in following Table 1.

TABLE 1

| | | Control unit |
|---|---|---|
| Target object | Control type | in charge |
| Engine/Motor | Raise a power threshold value required for starting an | HCU |
| | engine or motor (e.g., transitioning to a hybrid powertrain). | |
| | Prevent engine or motor from being started by air- | |
| | conditioning, catalyst-heating and warm-up requests. | |
| Air- | Limit or prevent air-conditioning power (e.g., limited to | HCU |
| conditioning | 50% of available power). | |
| | Prevent air-conditioning while the vehicle is stationary. | |
| Speed limit | Apply intelligent speed limit assist (ISLA) to manual speed | HCU |
| | limit assist (MSLA) or differentiate speed limits depending | |
| | on road types and/or road conditions. | |
| Acceleration | Reinforce APS scaling correction/demand torque filtering. | HCU |
| limit | Automatically activate an acceleration limiter. | |
| Parking | Reduce impact at a parking block or curb by reducing a | HCU |
| impact | creep torque or an acceleration torque during parking. | |
| | Perform activation in R (reverse) gear position or when a | |
| | parking assist system (PAS) is operated. | |
| Driving | Perform a vehicle driving evaluation function (e.g., | AVN/HCU |
| evaluation | implemented in a similar fashion to the ECO level). | |
| | Calculate a score by quantifying sudden | |
| | acceleration/sudden braking, a parking position, parking | |
| | impact, etc. | |
| Parking | Park the vehicle somewhere else when it is parked in a no- | CLU/HCU, |
| location | parking area, an area having a steep slope or an area having | SCU |
| | an excessive exposure to sunlight. | |
| | Perform demand output and parking prohibition control. | |
| Mode limit | Prohibit use of the sports mode. | CLU |
| | Forcibly execute the eco mode. | |
| Safety | Automatically activate an emergency braking apparatus, a | CLU |
| function | blind spot detection (BSD) system and/or a lane departure | |
| | warning system. | |
| | Increase the volume of alert sound. | |

In Table 1, HCU indicates a hybrid control unit, an AVN indicates an audio/video/navigation system, a CLU indicates a cluster control unit, and an SCU indicates a shift-by-wire (SBW) control unit. The respective target objects to be controlled, the control types and the control units in charge, set forth in Table 1, are merely exemplary, and the present disclosure is not limited thereto.

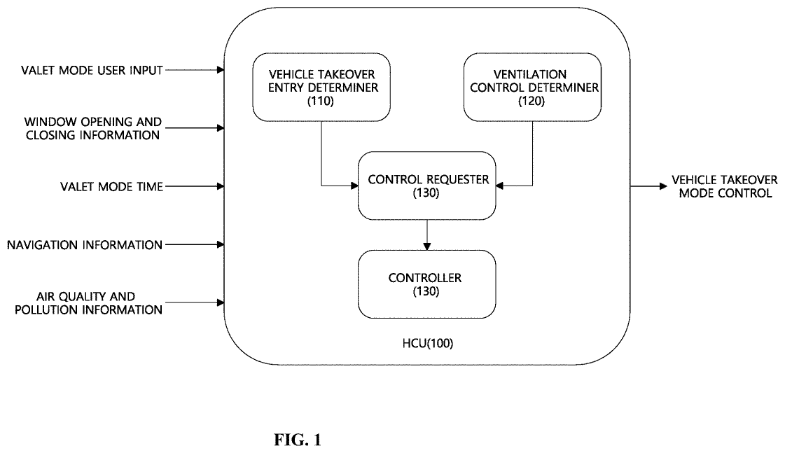

First, the configuration of a control unit which controls a valet mode function or a vehicle takeover mode function will be described with reference to FIG. 1.

FIG. 1 is a block diagram showing an example of the configuration of a valet mode control unit which controls the valet mode according to one embodiment of the present disclosure. One or more elements shown in FIG. 1 and other figures may be implemented as one or more computing devices and/or components. One or more elements shown in FIG. 1 and other figures may be implemented as hardware, software, or a combination of both. Modifications may be made to add, remove, combine, divide, etc. elements of, for example, a valet mode control unit 100. A computing device may include memory that stores computer-executable instructions that, when executed by one or more processors of the computing device, cause the computing device to perform one, some, or all of the operations described herein. Such memory and processor(s) may also or alternatively be implemented through one or more integrated circuits (ICs). An IC may be, for example, a microprocessor that accesses programming instructions or other data stored in a read-only memory (ROM) and/or hardwired into the IC. For example, an IC may comprise an application-specific integrated circuit (ASIC) having gates and/or other logic dedicated to the calculations and other operations described herein. An IC may perform some operations based on execution of programming instructions read from ROM or random-access memory (RAM), with other operations hardwired into gates or other logic. Further, an IC may be configured to output image data to a display buffer.

Referring to FIG. 1, a valet mode control unit 100 configured to control takeover of a vehicle in the valet mode may use valet mode user input information, vehicle status information including vehicle window opening and closing information, valet mode time information, navigation information, engine information, air quality and air pollution degree information, etc., as input information. Further, control commands regarding vehicle takeover mode control, which are transmitted to other control units, may be used as output information.

The valet mode user input information may be input through a command input unit provided in the vehicle, for example, a dial, a key button, a touch button, a touchscreen or the like, and may be transmitted via a telematics center by executing an application installed in a driver or user smart device, smart phone or portable terminal depending on implementation. Such input or transmission of the valet mode user input information is merely exemplary, and the present disclosure is not limited thereto.

The vehicle status information may be acquired through at least one vehicle sensor provided in the vehicle. For example, the vehicle status information may include information acquired by sensing a trunk, a sunroof, doors, windows, seats, etc. of the vehicle, but this information is merely exemplary, without being limited thereto. The vehicle window opening and closing information may be acquired by sensors provided in the windows of the vehicle, among the vehicle sensors.

The valet mode time information may be a time which is measured or counted from a point in time when the vehicle enters the valet mode. As the valet mode time information, a valet mode time may be set by a user or a vehicle owner in condition of a surrounding situation around the vehicle or the parking position of the vehicle, or the set valet mode time may be changed. This is merely exemplary, and the present disclosure is not limited thereto.

The navigation information may be acquired by the audio/video/navigation (AVN) system, and may include information regarding a road type corresponding to a road at the current position of the vehicle or a road located in front of the vehicle within in a designated distance, limit speeds, whether or not there is a parking lot, etc. Such information is merely exemplary, and the present disclosure is not limited thereto.

As the engine information, turning-on information and turning-off information of an engine may be acquired by the hybrid control unit.

The air quality and air pollution degree information may be acquired by sensing an external surrounding environment or an internal environment of the vehicle through the vehicle sensors provided in the vehicle, or may be acquired from an external server. The external server may be a server comprising an air quality measurement system or a national weather service (e.g., the Korean Metrological Administration). This is merely exemplary, and the present disclosure is not limited thereto.

Sources of the above-described respective input information are focused on initial sources of the corresponding information, and the input information may be information which is transmitted to the valet mode control unit 100 via other control units or be information which has been processed by other control units depending on the configuration of the vehicle.

The valet mode control unit 100 may include a vehicle takeover entry determiner 110, a ventilation control determiner 120, a control requester 130, and a controller 140.

The valet mode control unit 100 applicable to the embodiments of the present disclosure may be accompanied by control of the powertrain, and may thus be implemented as an upper-level control unit having the integrated control function of the powertrain, such as the vehicle control unit (VCU) in case of an electric vehicle (EV) or the hybrid control unit (HCU) in case of a hybrid electric vehicle (HEV), without being limited thereto.

Hereinafter, the respective elements of the valet mode control unit 100 will be described in more detail.

The vehicle takeover entry determiner 110 may determine whether or not predetermined vehicle takeover mode entry conditions are satisfied. The vehicle takeover entry determiner 110 may determine whether or not at least one of the predetermined vehicle takeover mode entry conditions is satisfied, and may determine activation of the vehicle takeover mode when a predetermined number (e.g., at least one) of the takeover mode entry conditions are satisfied. Examples of the predetermined takeover mode entry conditions are as follows, but the present disclosure is not limited thereto.
A vehicle takeover time (e.g., 2:35 PM), which the vehicle owner has set at or before the initiation of the valet mode, has been reached.
A vehicle (e.g., operated by a secondary driver) has deviated from a location/region for which the valet mode has been set and/or returned to the location/region.
The driver (e.g., a primary driver) has explicitly selected the vehicle takeover mode.
The primary driver (e.g., a vehicle owner) has received and approved a request to enter the vehicle takeover mode.
The frequency of starting and/or shutting down of the engine/motor of the vehicle has exceeded a predetermined value (e.g., a threshold value).
The engine/motor of the vehicle was started more than a predetermined time duration (e.g., a threshold time duration) after the last shut-down time of the engine/motor of the vehicle.

The ventilation control determiner 120 may determine whether or not a plurality of predetermined specialized ventilation mode entry conditions are satisfied based on the status of the vehicle and/or an external environment state in the valet mode. The ventilation control determiner 120 may determine whether or not at least one of the predetermined specialized ventilation mode entry conditions is satisfied, and may determine activation of a specialized ventilation mode of the vehicle when a predetermined number (e.g., at least one) of the specialized ventilation mode entry conditions is satisfied. Examples of the predetermined specialized ventilation mode entry conditions are as follows, but the present disclosure is not limited thereto.
One or more of an infectious disease risk index, an infection reproduction ratio (also referred to as a basic reproduction number) (e.g., an expected number of cases directly generated by one case in a population where all individuals are susceptible to infection), an air quality index, a fine dust concentration index, and/or any other factors and/or indexes indicating a need for air purification exceed threshold value(s) (e.g., as predetermined by the primary driver).
One or more atmospheric conditions (e.g., air quality, temperature, humidity, a fine dust concentration, and/or any other factors that may serve as indications of cleanliness) exceed threshold value(s) (e.g., as predetermined by the primary driver). Atmospheric conditions may be differently calculated depending on importance of each factor as determined by the vehicle owner. That is, the ventilation control determiner 120 may set a different weight value of each factor for atmospheric conditions or cleanliness depending on importance of each factor set by the vehicle owner, and may calculate an overall atmospheric condition (e.g., cleanliness) value based on the different weights of the respective factors.
A predetermined (e.g., threshold) time duration (e.g., predetermined by the primary driver) has elapsed since the valet mode was activated for the vehicle.
The primary driver (e.g., a vehicle owner) has explicitly requested to take over a certain ventilation control of the vehicle.

The control requester 130 may make a request for one of a plurality of takeover controls for a vehicle takeover entry mode based on the vehicle status, when the vehicle takeover entry determiner 110 may determine activation of a vehicle takeover mode function. The control requester 130 may make a request for one of the plurality of takeover controls for the vehicle takeover mode based on the vehicle status, if at least one of predetermined vehicle takeover entry mode conditions is satisfied. Examples of the predetermined vehicle takeover entry mode conditions are as follows, but the present disclosure is not limited thereto.
Controlling an air purification mode
Controlling air-conditioning
Accessing a vehicle status
Restoring a vehicle status (e.g., a seat position and/or state)
Requesting for adjusting (e.g., mitigation and/or release) of valet mode specialization level control limits. A valet mode specialization level control limit may be a limitation applied to the vehicle while the vehicle is in valet mode (e.g., an air-conditioning limit control level, etc.).

The controller 140 may perform vehicle control corresponding to the requested takeover control. The controller 140 may perform each vehicle control so as to correspond to at least one requested takeover control. Examples of the respective vehicle controls are as follows, but the present disclosure is not limited thereto.
The valet mode specialization level control limits are mitigated and/or released. For example, air-conditioning power may be adjusted and/or limited based on a plurality of levels, such as during driving of the vehicle through valet mode-specialized control, during operation of the parking assist system (PAS), during parking of the vehicle, and/or while the vehicle is stationary in a P (parking) gear position. That is, air-conditioning (A/C) power correction level mitigation and release, and power increase control for a designated time may be performed.

For example, (1) a correction factor (e.g., a multiplier) may be mitigated as the vehicle takeover time or distance is reached; (2) The correction factor may be mitigated or a limit thereon may be released based on a difference between the interior temperature of the vehicle and an external temperature; (3) if the interior temperature of the vehicle is greater than or equal to a threshold value and a predetermined time approaches, when a predetermined number (e.g., at least one) of the vehicle takeover mode entry conditions is satisfied, the correction factor may be mitigated or the limit thereon may be released, and power may also be increased for a designated time duration. For example, when the external temperature is 32° C., the interior temperature of the vehicle is 30° C., and the primary driver (e.g., a vehicle owner) is planning to take over the vehicle in 20 minutes, an A/C power limit may be released (e.g., removed), and the A/C power may be increased for a designated time duration (e.g., for 5 minutes); and (4) When the engine or motor of the vehicle is started so as to execute the vehicle takeover mode, valet mode-specialized control which limits the A/C power may be ignored.

Further, the controller 140 may purify the air inside the vehicle under the control of the hybrid control unit (HCU). For example, the controller 140 may control the internal pressure of the vehicle to be lower than the external pressure of the vehicle, thereby allowing the air inside the vehicle to be discharged to the outside.

The controller 140 may control air purification within the vehicle through a first step to a fourth step.

In the first step, the status of the vehicle may be confirmed. For example, the controller 140 may confirm the status of the vehicle using at least one vehicle sensor. For example, the operating status of the vehicle may be confirmed by sensing the states of the sunroof, the doors, the trunk, the windows, etc. of the vehicle through the vehicle sensors.

The controller 140 may perform control so as to open only the window at the driver's seat, when it is sensed that all the sunroof, the doors, the trunk and the windows of the vehicle are closed. However, the controller 140 is not limited thereto, and may perform control so as to open or close the windows of the vehicle depending on the status of the vehicle.

For example, the controller 140 may perform control so that only the window at the driver's seat is open and all other windows of the vehicle are closed, or may make a request to close the windows of the vehicle other than the windows at the driver's seat when they are not closed and to open the windows at the driver's seat when it is not open.

Further, the controller 140 may confirm full automatic temperature controller (FATC) limit control so as to control or adjust air flow from the vents. The FATC may have been limited by a predetermined valet mode level.

In addition, the controller 140 may confirm the engine/motor start time or the engine/motor shut-off time of the vehicle. By varying air purification control based on a time duration for which the vehicle was unattended (e.g., without an occupant) in valet mode, a better interior environment of the vehicle may be created.

In the second step, air-conditioning control of the vehicle may be requested. That is, the controller 140 may make a request for air flow control to an air-conditioning control unit, when the status of the vehicle is confirmed.

In the third step, control of the air-conditioning control unit may be performed. In the third step, the air-conditioning control unit may perform at least one of a plurality of controls. For example, the air-conditioning control unit may control the vehicle in an outdoor air mode under the control of the controller 140 (e.g., outdoor air inflow), and may control all air vents of the vehicle or particular air vents selected by the driver, or may control the intensity of air flow from the air vents to be set to the maximum intensity, an intensity set by the driver, and/or an intensity based on a time duration for which the vehicle is left unattended (e.g., without an occupant).

In the fourth step, air purification may be requested. That is, the controller 140 may control the air-conditioning control unit so as to purify the air inside the vehicle, if, for example, the primary driver (e.g., a vehicle owner) sits on the driver's seat.

As described above, the valet mode control unit 100 may control ventilation so as to discharge the air inside the vehicle to the outside to more rapidly and thoroughly ventilate the inside of the vehicle, or may control air-cleaning, air purification, vehicle status restoration, limit amount mitigation (e.g., valet mode-specialized control), before the primary driver (e.g., a vehicle owner) takes over the vehicle, based on a time for which the vehicle is left during activation of the vehicle takeover mode, an estimated vehicle takeover time, a driving distance, a takeover distance of the vehicle, the valet mode user input information, opening and closing information of the vehicle windows, valet mode time information, navigation information, engine turning-on information, air quality and air pollution information, etc. Here, the frequency of turning-on of the engine, the frequency of starting and turning-off of the engine of the vehicle, etc. may be applied only to eco-friendly vehicles (e.g., HEVs and plug-in hybrid electric vehicles (PHEVs)) provided with an engine.

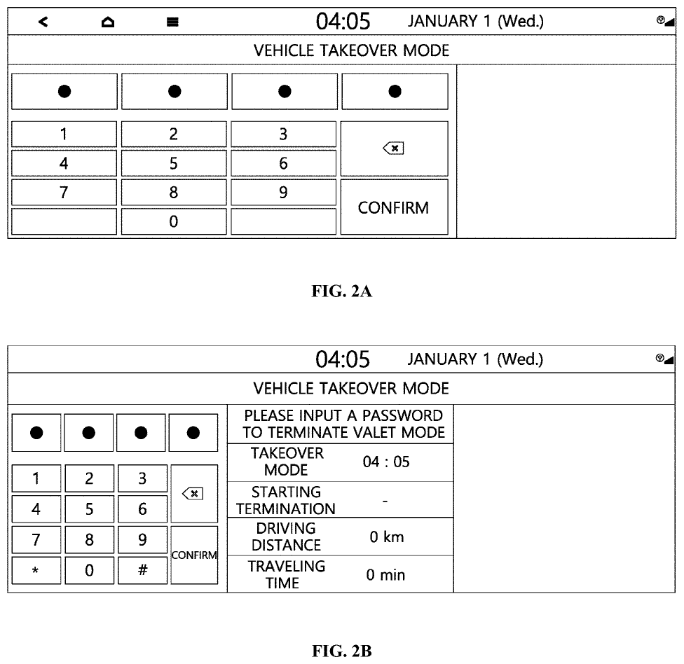

FIGS. 2A and 2B are diagrams showing an example of implementation of the vehicle takeover mode.

Referring to FIGS. 2A and 2B, the vehicle takeover mode may be a mode in which limits of at least some functions and performances of a vehicle are adjusted (e.g., mitigated) and/or released while a secondary driver (e.g., a valet driver, a driver other than a vehicle owner, etc.) is driving the vehicle to a location desired by the primary driver (e.g., a vehicle owner) in valet mode.

The primary driver (e.g., a vehicle owner) may access a vehicle owner or user setting menu (USM) for the vehicle takeover mode by inputting a designated command through the AVN system. For example, the primary driver (e.g., a vehicle owner) may access a menu for releasing level setting for limiting air-conditioning or a menu for releasing level setting for limiting a driving mode in the user setting menu (USM) for the vehicle takeover mode.

In each menu, a description of functions which become current target objects to be set may be displayed on the AVN system.

For example, the valet mode control unit 100 may display a screen for setting a password, after the vehicle owner selects the vehicle takeover mode in the user setting menu (USM). The valet mode control unit 100 may determine that at least one of the vehicle takeover mode entry conditions is satisfied, after the password is set.

When the vehicle enters the vehicle takeover mode, an example screen shown in FIG. 2B may be displayed, but the present disclosure is not limited thereto.

For example, the AVN system may display a vehicle takeover mode start time, an estimated vehicle takeover time, a driving distance, limit release, etc. under the control of the valet mode control unit 100. The corresponding information may be confirmed (e.g., accessed) through an application installed in the smart device of the primary driver under the control of the valet mode control unit 100. For example, the application may be a Bluelink application, and vehicle position information may also be displayed. Bluelink® is a telematics service provided by Hyundai Motor Company of Seoul, South Korea, but it may be any telematics service for the purpose of this disclosure.

Further, the valet mode control unit 100 may control operation of a rear-view camera (e.g., a backup camera) of the vehicle, an emergency call (SOS), etc. in the vehicle takeover mode.

In addition, the valet mode control unit 100 may gradually mitigate and/or release the limit on the air-conditioning control unit or the driving mode limit, when the set password is input through the smart terminal of the vehicle owner during the vehicle takeover mode.

For example, the valet mode control unit 100 may gradually decrease (e.g., mitigate and/or release) the limit on the air-conditioning control unit or the driving mode limit, as the estimated vehicle takeover time draws near or an estimated takeover distance (e.g., a distance to a location where full takeover is to take place) decreases. However, the present disclosure is not limited thereto, and the valet mode control unit 100 may release the limit on the air-conditioning control unit or the driving mode limit, when the primary driver (e.g., a vehicle owner) completely takes over the vehicle.

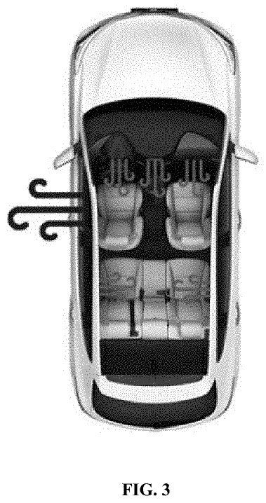

FIG. 3 is a diagram illustrating an example operation of the air-conditioning control unit under the control of the valet mode control unit.

Referring to FIG. 3, the valet mode control unit 100 may perform one control or a plurality of controls by controlling the air-conditioning control unit in the vehicle takeover mode. For example, the valet mode control unit 100 may control the air-conditioning control unit so as to purify the air inside the vehicle. Here, the air-conditioning control unit may discharge the air inside the vehicle to the outside through control in which negative pressure is generated inside the vehicle.

The valet mode control unit 100 may control the air-conditioning control unit to perform confirmation (e.g., access) of the vehicle status, to make a request for air-conditioning control, to perform air-conditioning control, and/or to make a request for air-cleaning. A detailed description thereof has been given above with reference to FIG. 1, and will thus be omitted herein.

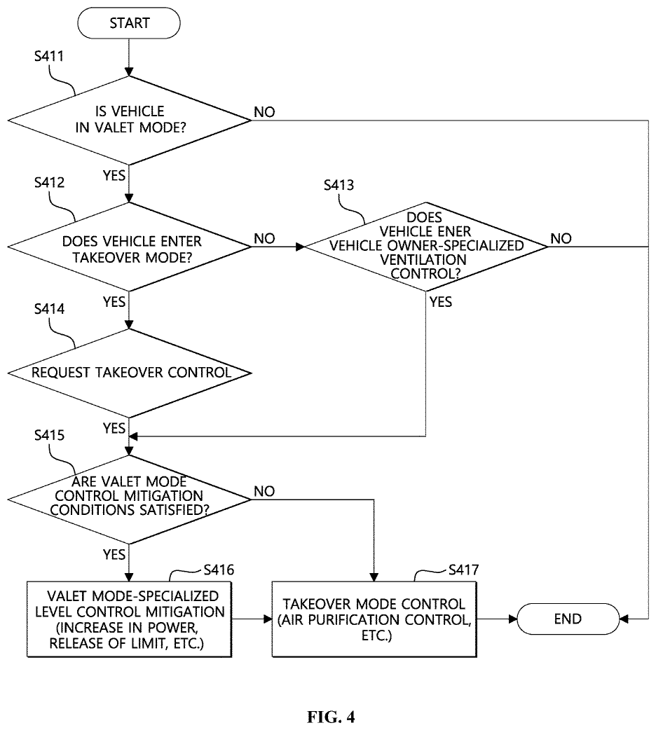

A process of controlling the above-described vehicle takeover mode will be summarized with reference to FIG. 4.

FIG. 4 is a flowchart representing an example of the process of controlling the vehicle takeover mode during the valet mode. The method or algorithm shown in FIG. 4 and other figures may be performed by one or more devices described herein. The method or algorithm shown in FIG. 4 and other figures may be embodied in computer-executable instructions that are stored in a non-transitory computer readable medium. The steps in this flow chart need not all be performed in the order specified and some steps may be omitted, added, or changed in order.

Referring to FIG. 4, the valet mode control unit 100 may determine whether a vehicle (e.g., an eco-friendly vehicle) is in valet (S411). If the vehicle is not in valet mode (No in S411), the valet mode control unit 100 may terminate the process.

If the vehicle is in valet mode (Yes in S411), the valet mode control unit 100 may control the vehicle takeover entry determiner 110 so as to determine whether or not a predetermined number (e.g., at least one) of the vehicle takeover mode entry conditions is satisfied (S412). The vehicle takeover entry determiner 110 may determine whether or not the predetermined number (e.g., at least one) of the vehicle takeover mode entry conditions is satisfied in the valet mode under the control of the valet mode control unit 100.

The vehicle takeover entry determiner 110 may determine whether or not at least one of the predetermined vehicle takeover mode entry conditions is satisfied, and may determine activation of the vehicle takeover mode, if the predetermined number (e.g., at least one) of the predetermined vehicle takeover mode entry conditions is satisfied (Yes in S412). The predetermined vehicle takeover mode entry conditions may include, for example, a vehicle takeover time input by the primary driver (e.g., a vehicle owner) being reached, a vehicle (e.g., operated by a secondary driver) deviating from a location and/or region for which the valet mode is set and/or returning to the location and/or region, a driver (e.g., a primary driver) selecting the vehicle takeover mode, a primary driver (e.g., a vehicle owner) approving a vehicle takeover mode request that was received, a frequency of starting and shutting-off of the engine of the vehicle exceeding a predetermined value, and/or the engine or motor of the vehicle being started a predetermined time duration after the last shut-off of the engine or motor of the vehicle. However, the vehicle takeover mode entry conditions are not limited thereto.

If one or more predetermined vehicle takeover mode entry conditions are not satisfied (No in S412), the valet mode control unit 100 may control the ventilation control determiner 120 so as to determine whether or not a predetermined number (e.g., at least one) of a plurality of predetermined specialized ventilation mode entry conditions is satisfied based on the status of the vehicle and/or an external environment state (S413).

The ventilation control determiner 120 may determine whether or not a predetermined number (e.g., at least one) of the plurality of the predetermined specialized ventilation mode entry conditions is satisfied, and may determine activation of the specialized ventilation mode of the vehicle when the predetermined number (e.g., at least one) of the specialized ventilation mode entry conditions is satisfied. The predetermined specialized ventilation mode entry conditions may include, for example, an infectious disease risk index, a reproduction ratio, air quality, fine dust concentration, and/or any other factors and/or indexes indicating a need for air purification exceeding threshold value(s) (e.g., as predetermined by the primary driver); one or more atmospheric conditions (e.g., air quality, temperature, humidity, a fine dust concentration, and/or any other factors that may serve as indications for cleanliness) exceeding threshold value(s) (e.g., as predetermined by the primary driver); a time duration predetermined by the primary driver (e.g., a vehicle owner) has elapsed since the vehicle entered the valet mode; and/or the primary driver (e.g., a vehicle owner) has explicitly requested to take over control of the vehicle. However, the predetermined specialized ventilation mode entry conditions are not limited thereto.

Further, the ventilation control determiner 120 may variously calculate an overall atmospheric condition (e.g., cleanliness) value based on weighted factor(s) set by the primary driver (e.g., a vehicle owner) under the control of the valet mode control unit 100. That is, the ventilation control determiner 120 may set (e.g., assign) a different weight of each factor for cleanliness depending on importance of each factor set by the vehicle owner, and may calculate the overall atmospheric condition (e.g., cleanliness) value based on the different weights of the respective factors.

If the vehicle takeover entry determiner 110 determines activation of the vehicle takeover mode (Yes in S412), the control requester 130 may make a request for one of a plurality of takeover controls for the vehicle takeover mode based on the vehicle status (S414).

The plurality of takeover controls may include control of the air purification mode, control of air-conditioning, confirmation of the vehicle status, restoration of the vehicle status (e.g., a seat position and/or state), and requests for mitigation and/or release of valet mode specialization level control limits (e.g., an air-conditioning limit control level, etc.). However, the takeover controls are not limited thereto.

The controller 140 may perform vehicle control corresponding to the requested takeover control. That is, the controller 140 may determine whether or not valet mode control mitigation conditions are satisfied during performance of vehicle control (S415).

If the valet mode control mitigation conditions are satisfied (Yes in S415), the valet mode specialization level control limits may be mitigated and/or released (S416).

Air-conditioning power may be adjusted and/or limited based on a plurality of levels in a situation, such as during driving through valet mode-specialized control, during operation of the parking assist system (PAS), during parking of the vehicle, and/or while the vehicle is stationary in the P gear position. If the valet mode control mitigation conditions are satisfied (Yes in S415), air-conditioning (A/C) power correction level mitigation and release, and power increase control for a designated time may be performed (S416).

For example, a correction factor (e.g., a multiplier) may be mitigated as the vehicle takeover time or distance is reached. The correction factor may be mitigated or a limit thereon may be released based on a difference between the interior temperature of the vehicle and an external temperature. If the interior temperature of the vehicle is greater than or equal to a threshold value and a predetermined time approaches, when a predetermined number (e.g., at least one) of the vehicle takeover mode entry conditions is satisfied, the correction factor may be mitigated or the limit thereon may be released, and power may also be increased for a designated time duration. When the engine or motor of the vehicle is started so as to execute the vehicle takeover mode, valet mode-specialized control which limits the A/C power.

The controller 140 may purify the air in the internal environment of the vehicle (S417).

If the valet mode control mitigation conditions are not satisfied (No in S415), the controller 140 may purify the air in the internal environment of the vehicle (S417). For example, the controller 140 may control the internal pressure of the vehicle to be lower than the external pressure, so as to discharge the air inside the vehicle to the outside. A detailed description thereof has been given above with reference to FIG. 1, and will thus be omitted herein.

The present disclosure described above may be implemented as computer-readable code in a computer-readable recording medium (e.g., storage medium) in which programs (e.g., instructions) are recorded. Such computer-readable recording media may include all types of recording media in which data readable by computer systems is stored. For example, the computer-readable recording media may include a hard disk drive (HDD), a solid-state drive (SSD), a silicon disk drive (SDD), a ROM, a RAM, a compact disc read-only memory (CD-ROM), a magnetic tape, a floppy disk, an optical data storage device, etc.

As is apparent from the above description, an eco-friendly vehicle and a method for controlling a valet mode therefor according to various embodiments of the present disclosure may execute a vehicle takeover mode during the valet mode of the eco-friendly vehicle, and may thus control air-conditioning so as to clean air inside the eco-friendly vehicle before a vehicle owner takes over the eco-friendly vehicle, thereby being capable of improving convenience of the vehicle owner.

Further, the eco-friendly vehicle and the method for controlling the valet mode therefor according to various embodiments of the present disclosure may rapidly discharge air inside the vehicle to the outside so as to more rapidly and thoroughly ventilate the inside of the vehicle, or may perform air-cleaning, air purification control, vehicle status restoration, limit degree mitigation (i.e., valet mode-specialized control), etc. before the vehicle owner takes over the eco-friendly vehicle, thereby being capable of providing convenience to the vehicle owner and safely protecting the vehicle owner from dangerous infectious diseases.

In addition, the eco-friendly vehicle and the method for controlling the valet mode therefor according to various embodiments of the present disclosure may perform air-cleaning and purification, air-conditioning control, etc., at a point in time desired by the vehicle owner using an infectious disease risk index, air quality, target cleanliness, usage conditions in which cleaning is required, selected by the vehicle owner, a valet mode signal, etc. before the vehicle owner takes over the eco-friendly vehicle in the valet mode of the eco-friendly vehicle, thereby being capable of safely protecting the vehicle owner from dangerous infectious diseases and preventing viruses from spreading to the outside.

Moreover, the eco-friendly vehicle and the method for controlling the valet mode therefor according to various embodiments of the present disclosure may execute the vehicle takeover mode during the valet mode of the eco-friendly vehicle, and may thus control air-conditioning so as to clean air inside the eco-friendly vehicle before the vehicle owner takes over the eco-friendly vehicle, thereby being capable of thereby being capable of relieving anxiety of the vehicle owner and improving reliability in marketability of the vehicle.

It will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

What is claimed is:

1. A method comprising:
determining, by one or more processors and while a vehicle is in a valet mode, whether one or more vehicle takeover mode entry conditions are satisfied;
requesting, based on a determination that the one or more vehicle takeover mode entry conditions are satisfied and further based on a status of the vehicle, one of a plurality of takeover controls for a vehicle takeover mode; and
performing the requested takeover control on the vehicle by adjusting a limitation that is applied, in the valet mode, to the vehicle.

2. The method according to claim 1, wherein the one or more vehicle takeover mode entry conditions comprise at least one of:
a vehicle takeover time, selected by a primary operator of the vehicle, being reached;
the vehicle deviating from a location for which the valet mode is set;
the vehicle returning to the location for which the valet mode is set after deviating from the location;
receiving a request from the primary operator to activate the vehicle takeover mode;
receiving, from the primary operator, an approval of a request to activate the vehicle takeover mode;
a frequency of at least one of starting or shutting off a motor of the vehicle satisfying a threshold value; or
the motor of the vehicle being started a predetermined time duration after shutting off the motor.

3. The method according to claim 1, further comprising, based on a determination that the one or more vehicle takeover mode entry conditions are not satisfied, determining, further based on at least one of the status of the vehicle or an external environment state, whether one or more ventilation mode entry conditions are satisfied.

4. The method according to claim 3, wherein the one or more ventilation mode entry conditions comprise at least one of:
an infectious disease risk index, associated with an interior of the vehicle, satisfying a first threshold value;
an infection reproduction ratio, associated with the interior of the vehicle, satisfying a second threshold value;
an air quality index, associated with the interior of the vehicle, satisfying a third threshold value;
a fine dust concentration index, associated with the interior of the vehicle, satisfying a fourth threshold value;
a cleanliness value, associated with the interior of the vehicle, satisfying a fifth threshold value; or
a predetermined time duration elapsing since the valet mode is activated for the vehicle.

5. The method according to claim 1, wherein the adjusting the limitation comprises gradually decreasing the limitation based on at least one of a vehicle takeover time or a distance to a location associated with a full vehicle takeover.

6. The method according to claim 1, the performing the requested takeover control comprises purifying air in an interior of the vehicle.

7. The method according to claim 6, wherein the purifying the air comprises:
accessing the status of the vehicle; and
operating an air conditioner of the vehicle.

8. An apparatus for controlling a valet mode of a vehicle, the apparatus comprising:
one or more processors; and
memory storing instructions that, when executed by the one or more processors, cause the apparatus to:
determine, while the vehicle is in the valet mode, whether one or more vehicle takeover mode entry conditions are satisfied;
request, based on a determination that the one or more vehicle takeover mode entry conditions are satisfied and further based on a status of the vehicle, one of a plurality of takeover controls for a vehicle takeover mode; and
perform the requested takeover control on the vehicle by adjusting a limitation that is applied, in the valet mode, to the vehicle.

9. The apparatus according to claim 8, wherein the one or more vehicle takeover mode entry conditions comprise at least one of:
a vehicle takeover time, selected by a primary operator of the vehicle, being reached;
the vehicle deviating from a location for which the valet mode is set;
the vehicle returning to the location for which the valet mode is set after deviating from the location;
receiving a request from the primary operator to activate the vehicle takeover mode;
receiving, from the primary operator, an approval of a request to activate the vehicle takeover mode;
a frequency of at least one of starting or shutting off a motor of the vehicle satisfying a threshold value, or
the motor of the vehicle being started a predetermined time duration after shutting off the motor.

10. The apparatus according to claim 8, wherein the instructions, when executed by the one or more processors, further cause the apparatus to determine, based on a determination that the one or more vehicle takeover mode entry conditions are not satisfied and further based on at least one of the status of the vehicle or an external environment state, whether one or more ventilation mode entry conditions are satisfied.

11. The apparatus according to claim 10, wherein the one or more ventilation mode entry conditions comprise at least one of:
an infectious disease risk index associated with an interior of the vehicle, satisfying a first threshold value;
an infection reproduction ratio, associated with the interior of the vehicle, satisfying a second threshold value;
an air quality index, associated with the interior of the vehicle, satisfying a third threshold value;
a fine dust concentration index, associated with the interior of the vehicle, satisfying a fourth threshold value;
a cleanliness value, associated with the interior of the vehicle, satisfying a fifth threshold value; or
a predetermined time duration elapsing since the valet mode is activated for the vehicle.

12. The apparatus according to claim 8, wherein the instructions, when executed by the one or more processors, cause the apparatus to adjust the limitation by gradually decreasing the limitation based on at least one of a vehicle takeover time or a distance to a location associated with a full vehicle takeover.

13. The apparatus according to claim 8, wherein the instructions, when executed by the one or more processors, cause the apparatus to perform the requested takeover control by purifying air in an interior of the vehicle.

14. A non-transitory computer-readable storage medium storing instructions, when executed by one or more processors, cause an apparatus to:
determine, while a vehicle is in a valet mode, whether one or more vehicle takeover mode entry conditions are satisfied;
request, based on a determination that the one or more vehicle takeover mode entry conditions are satisfied and further based on a status of the vehicle, one of a plurality of takeover controls for a vehicle takeover mode; and
perform the requested takeover control on the vehicle by adjusting a limitation that is applied, in the valet mode, to the vehicle.

15. The non-transitory computer-readable storage medium according to claim 14, wherein the one or more vehicle takeover mode entry conditions comprise at least one of:
a vehicle takeover time, selected by a primary operator of the vehicle, being reached;
the vehicle deviating from a location for which the valet mode is set;
the vehicle returning to the location for which the valet mode is set after deviating from the location;
receiving a request from the primary operator to activate the vehicle takeover mode;
receiving, from the primary operator, an approval of a request to activate the vehicle takeover mode;
a frequency of at least one of starting or shutting off a motor of the vehicle satisfying a threshold value, or
the motor of the vehicle being started a predetermined time duration after shutting off the motor.

16. The non-transitory computer-readable storage medium according to claim 14, wherein the instructions, when executed by the one or more processors, further cause the apparatus to determine, based on a determination that the one or more vehicle takeover mode entry conditions are not satisfied and further based on at least one of the status of the vehicle or an external environment state, whether one or more ventilation mode entry conditions are satisfied.

17. The non- transitory computer-readable storage medium according to claim 16, wherein the one or more ventilation mode entry conditions comprise at least one of:
an infectious disease risk index, associated with an interior of the vehicle, satisfying a first threshold value;
an infection reproduction ratio, associated with the interior of the vehicle, satisfying a second threshold value;
an air quality index, associated with the interior of the vehicle, satisfying a third threshold value;
a fine dust concentration index, associated with the interior of the vehicle, satisfying a fourth threshold value;
a cleanliness value, associated with the interior of the vehicle, satisfying a fifth threshold value; or a predetermined time duration elapsing since the valet mode is activated for the vehicle.

18. The non-transitory computer-readable storage medium according to claim 14, wherein the instructions, when executed by the one or more processors, cause the apparatus to adjust the limitation by gradually decreasing the limitation based on at least one of a vehicle takeover time or a distance to a location associated with a full vehicle takeover.

19. The non-transitory computer-readable storage medium according to claim 14, wherein the instructions, when executed by the one or more processors, cause the apparatus to perform the requested takeover control by purifying air in an interior of the vehicle.

20. The non-transitory computer-readable storage medium according to claim 19, wherein the instructions, when executed by the one or more processors, cause the apparatus to purify the air by:
accessing the status of the vehicle; and
operating an air conditioner of the vehicle.
